(19) United States
(12) Patent Application Publication
(10) Pub. No.: US 2025/0240817 A1
(43) Pub. Date: Jul. 24, 2025

(54) MANAGED PEER-TO-PEER (P2P) GROUPS AND ASSOCIATED ACCESS MECHANISMS

(71) Applicant: MaxLinear, Inc., Carlsbad, CA (US)

(72) Inventors: Iñaki Val Beitia, Vitoria (ES); Sigurd Schelstraete, Menlo Park, CA (US); Marcos Martínez Vázquez, Barcelona (ES)

(73) Assignee: MaxLinear, Inc., Carlsbad, CA (US)

(21) Appl. No.: 19/036,829

(22) Filed: Jan. 24, 2025

Related U.S. Application Data
(60) Provisional application No. 63/724,758, filed on Nov. 25, 2024.
(60) Provisional application No. 63/699,090, filed on Sep. 25, 2024.
(60) Provisional application No. 63/563,186, filed on Mar. 8, 2024.
(60) Provisional application No. 63/624,748, filed on Jan. 24, 2024.

(51) Int. Cl. H04W 74/0808

(52) U.S. Cl. CPC H04W 74/0808

(57) ABSTRACT

Technology is disclosed for an access point (AP). The access point may include a processing device. The processing device may gain, at the AP, a specific bandwidth for a secondary channel in a transmission opportunity (TXOP). The processing device may send, from the AP to a plurality of stations (STAs), an initial control frame (ICF), wherein the ICF signals a frame exchange start for a peer-to-peer (P2P) group of the plurality of STAs and assigns the secondary channel to the P2P group of the plurality of STAs. The processing device may receive, from the P2P group of the plurality of STAs on the secondary channel, a first set of initial control responses (ICRs).

### RELATED APPLICATION

This application claims the benefit of U.S. Provisional Application No. 63/624,748, filed Jan. 24, 2024, U.S. Provisional Application No. 63/563,186, filed Mar. 8, 2024, U.S. Provisional Application No. 63/699,090, filed Sep. 25, 2024, and U.S. Provisional Application No. 63/724,758, filed Nov. 25, 2024, the disclosures of which are each incorporated herein by reference in their entirety.

The examples discussed in the present disclosure are related to managed peer-to-peer groups and associated access mechanisms for access points (APs) and stations (STAs).

### BACKGROUND

Unless otherwise indicated herein, the materials described herein are not prior art to the claims in the present application and are not admitted to be prior art by inclusion in this section.

An access point (AP), is a networking hardware device that allows other Wi-Fi® devices to connect to a wired network. As a standalone device, the AP may have a wired connection to a router, but, in a wireless router, it can also be an integral component of the router itself. There are many wireless data standards that have been introduced for wireless access point and wireless router technology such as 802.11a, 802.11b, 801.11g, 802.11n (Wi-Fi® 4), 802.11ac (Wi-Fi® 5), 802.11ax (Wi-Fi® 6), and so forth.

The subject matter claimed in the present disclosure is not limited to examples that solve any disadvantages or that operate only in environments such as those described above. Rather, this background is only provided to illustrate one example technology area where some examples described in the present disclosure may be practiced.

### BRIEF DESCRIPTION OF THE DRAWINGS

Examples will be described and explained with additional specificity and detail through the use of the accompanying drawings in which:

FIG. 1 illustrates an example wireless local area network environment for peer-to-peer (P2P) communication for a first station (e.g., a laptop) and a second station (e.g., a printer) over transmission control protocol (TCP), exchanging data (D) and acknowledgement (A) frames over a P2P link.

FIG. 2 illustrates an example timing diagram for packet exchange for triggered transmission opportunity (TXOP) sharing mode 2.

FIG. 3 illustrates an example wireless local area network environment for P2P bidirectional data exchange for a P2P group of three devices.

FIG. 4 illustrates an example timing diagram showing a packet sequence for P2P bidirectional data exchange using triggered access mechanisms.

FIG. 5A illustrates an example timing diagram showing a packet sequence for P2P bidirectional data exchange (without acknowledgment (ACK)) using light-weight contention access mechanism.

FIG. 5B illustrates an example timing diagram showing a packet sequence for P2P bidirectional data exchange (with ACK) using light-weight contention access mechanism.

FIG. 6A illustrates an example timing diagram showing a packet sequence for P2P bidirectional data exchange using a light-weight contention access mechanism.

FIG. 6B illustrates an example timing diagram showing a packet sequence for P2P bidirectional data exchange using a light-weight contention access mechanism.

FIG. 7 illustrates an example timing diagram showing a packet sequence for P2P bidirectional data exchange (with ACK) using token-based access mechanism.

FIG. 8 illustrates an example of dynamic sub-band operation for P2P communication.

FIG. 9 illustrates P2P bidirectional data exchange in parallel with regular DL/UL

FIG. 10 illustrates a block diagram of an example system configured to perform P2P communication.

FIG. 11 illustrates an example process flow for P2P communication.

FIG. 12 illustrates an example process flow for P2P communication.

FIG. 13 illustrates an example process flow for P2P communication.

FIG. 14 illustrates an example process flow for P2P communication.

FIG. 15 illustrates an example process flow for P2P communication.

FIG. 16 illustrates a diagrammatic representation of a machine in the example form of a computing device within which a set of instructions, for causing the machine to perform any one or more of the methods discussed herein, may be executed.

### DESCRIPTION

There exist different applications that use two or more (non-AP) devices (e.g., wireless stations (STAs)) to communicate within the same local area network (LAN), such as document printing, file transfer, internal video streaming, photo viewing, and virtual reality among others. The actual communication may be done directly or through an intermediate device. In the case of Wi-Fi® technology, the STAs may not be allowed to directly communicate with each other. Therefore, the Access Point (AP) may be an intermediary, where the AP may transfer the data from one device to another, using consecutive uplink (UL) and downlink (DL) data transactions. That is, the AP may centralize communication in a shared media.

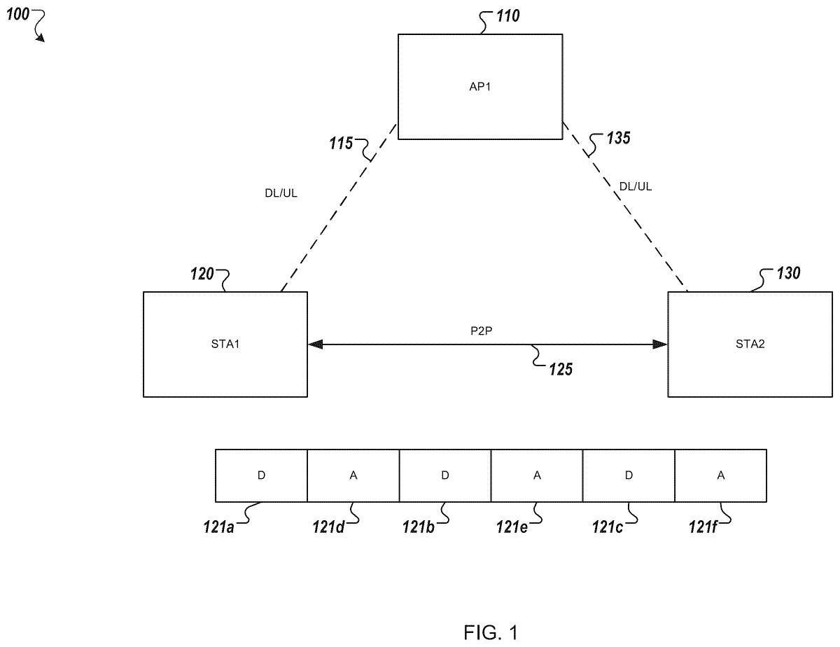

This method may be inefficient for this kind of application, where more direct communications between the devices may speed up the throughput and reduce the airtime employed for the communication. To this end, peer-to-peer (P2P) communication was established, allowing direct communication between two STAs for a limited period of time. As illustrated in FIG. 1, a wireless system 100 may include a STA1 120 (e.g., a laptop) and STA2 130 (e.g., a printer) that may be associated with AP1 110 (i.e., using a first link 115 and a second link 135, respectively), but may communicate directly with each other through a P2P link 125. The communication between STA1 120 and STA2 130 may use transmission control protocol (TCP) which may be used to exchange data frames 121a, 121b, 121c and acknowledgment frames 121d, 121e, 121f over the P2P link 125.

The 802.11be amendment defines the Triggered Transmission opportunity (TXOP) sharing mechanism, allowing the AP to share its gained TXOP with a specific STA, allowing that STA to use this time for transferring data to the AP (mode 1) or transferring data to another STA (mode 2). A P2P link may be established, without using an AP to transfer data and in a contention-free situation, when the TXOP has been granted to the STA.

For P2P applications, a TCP protocol may be used for sending the data, which may use bidirectional exchange of data/(TCP) ACK frames, providing the data transfer, and adapting the protocol to the channel status (e.g., as illustrated in FIG. 1). Other applications, even when TCP is not used, may be based on closing a data loop that may use bidirectional communication. For example, virtual reality glasses receive video and audio, but may also send back the position of the glasses for adapting the video image in the next frame.

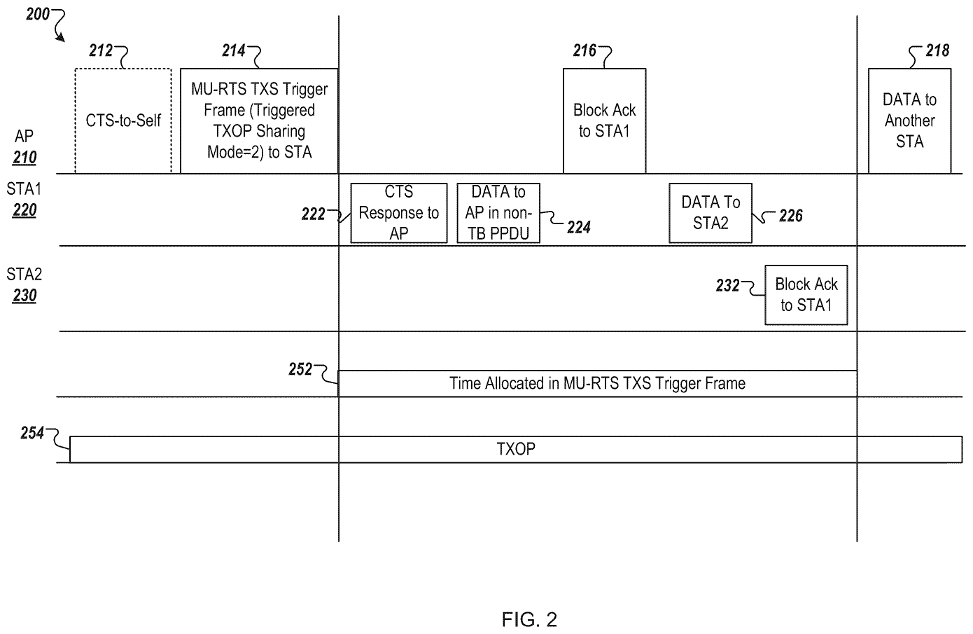

The triggered TXOP sharing (mode 2) mechanism may be limited to transferring data in one direction, as illustrated in FIG. 2. The granted STA can send data to another STA, but the STA cannot receive data from another one, as it does not have the mechanisms such as trigger frames. The following text from the IEEE 802.11be D5.0 discloses:
The non-AP EHT STA may use the time allocated by the associated AP in an MU-RTS TXS Trigger frame, which is addressed to the STA and that has the Triggered TXOP Sharing Mode subfield equal to 2, for the transmission of one or more non-TB PPDUs that are addressed to the AP or to another STA. The non-AP EHT STA that received an MU-RTS TXS Trigger frame with TXOP Sharing Mode subfield equal to 2 may transmit, within an allocated time, a QoS Data or QoS Null frame that includes an HE variant HT Control field with a CAS Control subfield with the RDG/More PPDU subfield equal to 0 to the associated AP from which it has received an EHT Capabilities element with the TXOP Return Support in TXOP Sharing Mode 2 subfield set to 1. Otherwise, the STA shall not transmit such frame to its associated AP within the allocated time.

As illustrated in FIG. 2, a block diagram 200 provides the functionality for the triggered TXOP sharing (mode 2) mechanism which may be limited to transferring data in one direction. The AP 210 may send a clear-to-send (CTS)-to-self signal, as shown in operation 212, to itself. The AP 210 may send a multi-user request-to-send (MU-RTS) TXOP sharing (TXS) trigger frame, which may be triggered TXOP sharing mode 2, to a STA1 220 and a STA2 230, as shown in operation 214. The STA1 220 may send a CTS response to AP to the AP 210, as shown in operation 222. The STA1 220 may send data to the AP 210 in non-trigger-based physical layer protocol data unit (TB PPDU), as shown in operation 224. The AP 210 may send a block ACK to STA1 220, as shown in operation 216. The STA1 220 may send data to the STA2 230, as shown in operation 226. The STA2 230 may send a block ACK to the STA1 220, as shown in operation 232. The time allocated in the MU-RTS TXS trigger frame may include the time between: (i) after the sending of the MU-RTS TXS trigger frame, and (ii) after the sending of the block ACK to the STA1 220, as shown in block 252. The TXOP 254 may include the time from between: (i) the beginning of the sending of the CTS-to-Self as shown in operation 212, and (ii) the end of the sending of data from the AP to another STA, as shown in block 218.

In summary, the TXOP sharing (mode 2) mechanism does not provide optimal functionality for directly communicating two (or more) STA devices that use bidirectional data exchange.

Disclosed herein are coordinated scheduling mechanisms for creating and managing P2P groups of two or more STA devices, reducing the overhead in the access point, and establishing a unidirectional or bidirectional communication in a controlled environment.

There are several mechanisms for allowing bidirectional communication of P2P group members, reducing the overhead generated by MU TXOP sharing mode 2. First, light-weight contention mechanism may allow the P2P group devices to communicate directly without the intervention of the AP, allowing bidirectional communication between the P2P group members. Second, token-based mechanisms may allow the P2P group devices to communicate directly without the intervention of the AP, allowing bidirectional communication between the P2P group members.

Additionally, the proposed mechanism shares the spectral resources, not only time resources (TXOP). Assuming the AP gets enough bandwidth during the initial contention process, the allocated bandwidth may be divided into a primary and secondary channel. While the AP and its associated STAs may continue transferring data on the primary channel, the P2P devices may jump to the secondary channel once the TXOP is shared. In this way, DL/UL and P2P transactions may continue simultaneously, reducing the increase of the latency. The time and spectrum resources may be shared from the acquired TXOP.

Examples of the present disclosure will be explained with reference to the accompanying drawings.

### P2P Groups

The triggered TXOP sharing (mode 2) mechanism may send data in one direction during the granted TXOP but may not send data in the opposite direction. A mechanism may be used that eases the bidirectional data transfer between the two (or more) non-AP STAs in order to cover the application service standards. For a specific shared TXOP, a group of P2P STAs may be involved in a communication service.

An AP may include a processing device that may receive, at the AP from a first STA, a first stream classification service (SCS) request; receive, at the AP, from a second STA, a second SCS request; generate, at the AP, a P2P group comprising the first STA and the second STA; and signal, from the AP to the first STA and second STA, the P2P group using a shared gained transmission opportunity (TXOP). The first SCS request and/or the second SCS request may be extremely high throughput.

The AP may schedule its execution over time. In one example, the AP scheduling may be periodic. In another example, the AP scheduling may be aperiodic. The AP may create and announce the creation of the P2P group. The P2P group may be generated based on quality of service (QoS) standards. The AP may allocate a P2P time period (e.g., within the shared TXOP).

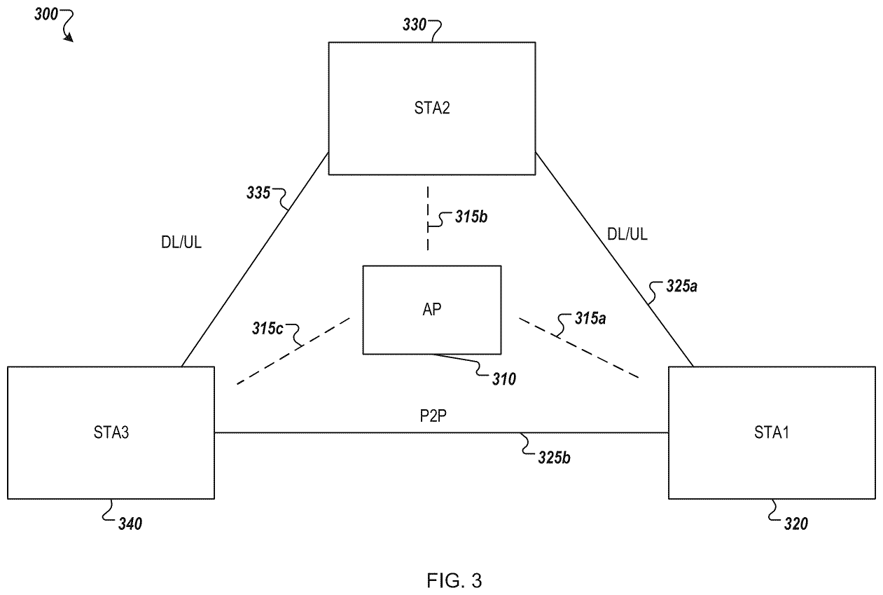

As illustrated in FIG. 3, an example wireless local area network environment 300 for P2P bidirectional data exchange for a P2P group of three devices may be a home networking application for video entertainment including a STA1 320 (e.g., a TV), a STA2 330 (e.g., sound speakers), a STA3 340 (e.g., Network Attached Storage (NAS)), and an AP 310.

The P2P group may be declared employing direct link EHT SCS requests sent to the AP 310 from the STAs 320, 330, 340 using direct links 315a, 315b, 315c. The AP 310 may recognize the standards for their common application service, and build the P2P group (e.g., including STAs 320, 330, and 340). The AP 310 may schedule its execution over the time (periodic or aperiodic). The creation of the P2P group may ensure that the specific P2P mechanism may be limited to that group, which may be allowed to use specific P2P group access mechanisms. STA 1 320 may be connected to STA2 330 using connection 325a and may be connected to STA3 using connection 325b. STA2 330 may be connected to STA3 340 using connection 335. In summary, the STAs 320, 330, 340 may request the creation of a common P2P group, the AP 310 may create and announce it based on QoS standards, and the AP 310 may signal the start of the P2P group within the shared TXOP, gained by the AP.

### P2P Access Mechanisms

### Triggered Access

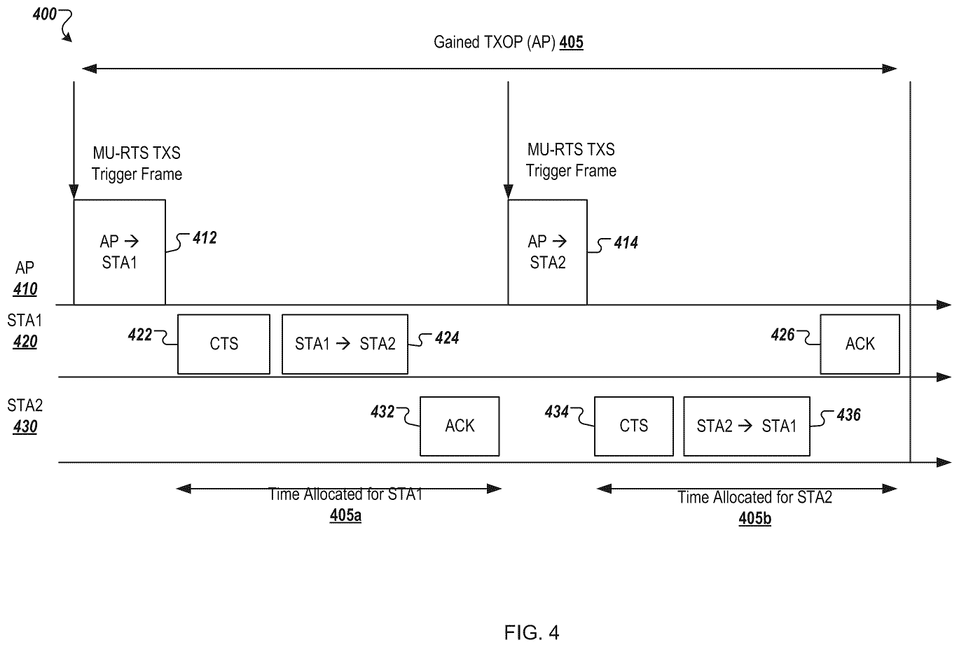

Triggered TXOP sharing mode 2 may have limitations for a generic P2P application case in which the AP creates P2P links for each direction sequentially, as illustrated in the diagram 400 in FIG. 4, the expected efficiency of P2P links may be lost when compared to a trigger-based communication managed by the AP in which the AP may not process the incoming STA frames and redirect them to its peer.

FIG. 4 shows the data exchange in two directions within the same AP TXOP (e.g., Gained TXOP (AP) 405), which may be divided into two independent sharing periods, one for each STA (e.g., time allocated for STA1 405a and time allocated for STA2 405b). This mechanism may allow the exchange of data in both directions between the two STAs 420, 430 from the same P2P group, avoiding contention for gaining the channel in each direction. The presented mechanism may have a similar frame exchange structure to the one provided by the AP using trigger-based frames. In both cases, AP scheduling capabilities may be used.

As illustrated in FIG. 4, an AP 410 may send a first MU-RTS TXS trigger frame to the first STA 420, as shown in operation 412. The AP 410 may send a second MU-RTS TXS trigger frame to the second STA 430, as shown in operation 414. The AP 410 may receive, at the AP 410 from the first STA 420, a first CTS frame, as shown in operation 422, and receive, at the AP 410 from the second STA 430, a second CTS frame, as shown in operation 434. The AP 410 may generate a first-direction P2P link and a second-direction P2P link. The AP 410 may generate the first-direction P2P link and the second-direction P2P link sequentially.

The STAs 420, 430 may send data between each other. STA1 420 may send data to STA2 430, as shown in operation 424. STA2 420 may send an ACK message to STA1 420, as shown in operation 432. STA2 430 may send data STA1 420, as shown in operation 436. STA1 may send an ACK message to STA1, as shown in operation 426.

### Light-weight Contention

P2P links may alleviate the AP from overhead transferring data between STAs (unidirectional or bidirectional), which may increase the airtime efficiency and enhance P2P application performance. The triggered access mechanism, based on triggering the STA for sharing the TXOP, uses the intervention of the AP when the P2P application exchanges data in both directions.

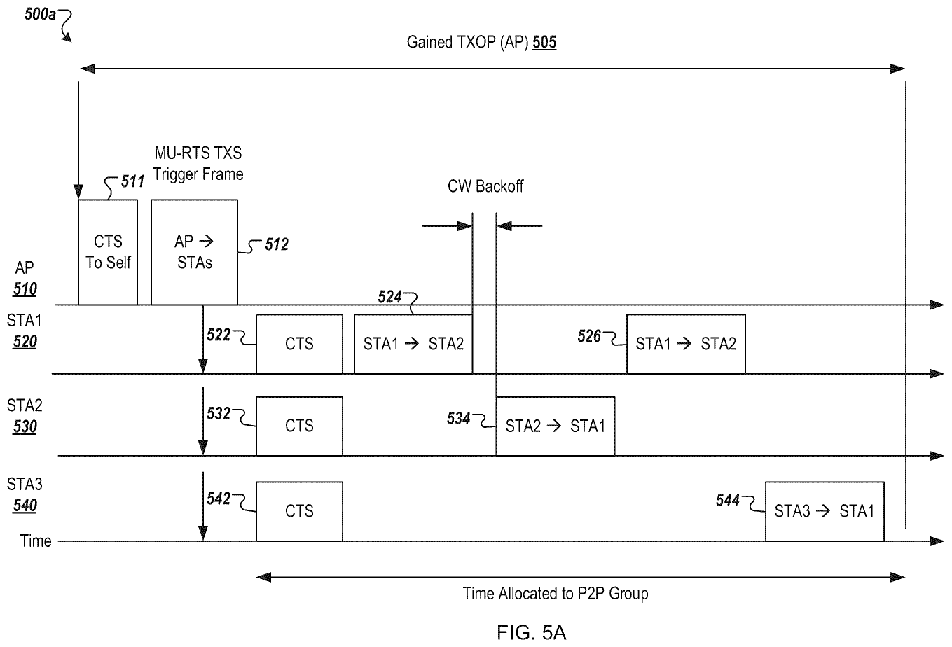

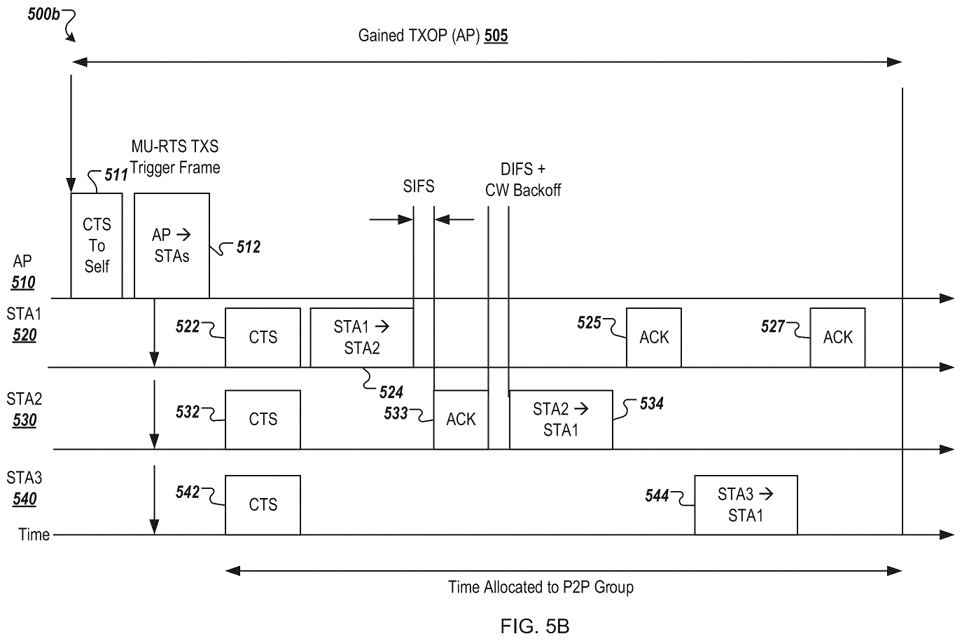

In the case of having a P2P group of three or more devices, the AP scheduling may be more complex. As shown in the timing diagram 500a in FIG. 5, the AP 510 may send the MU-RTS TXS Trigger frame to the P2P group, as shown in operation 512, and the P2P group (e.g., STA1 520, STA2 530, STA3 540) may send back a CTS frame, as shown in operations 522, 532, 542, acknowledging the AP 510.

When the P2P group includes a small number of devices (e.g., up to four devices), a low congested scenario may result. That is, the AP 510 may share the TXOP (e.g., gained TXOP) with the P2P group and create a contention time window for the STAs (e.g., STA1 520, STA2 530, STA3 540). Because the communication of these devices is driven by the P2P application, the shared TXOP may be restricted to a specific service or traffic priority. Consequently, there may not be many access collisions between the P2P group members. Therefore, channel access fairness within the same P2P group may be achieved.

A light-weight contention mechanism may reduce the time used to gain the channel when compared to the case of using Distributed Coordination Function (DCF) rules. The contention window (CW) back-off parameter may be smaller to reduce the time for accessing the channel and increase the efficiency by reducing the overhead. With one traffic priority service, distinction of access categories (ACs) may not be used; therefore the devices may start the contention after waiting for DCF InterFrame Space (DIFS) time. When acknowledgment frames are not used, the DIFS may be omitted because the DIFS allows for other devices to get access to the medium with a higher priority; therefore Short Interframe Space (SIFS) time may be used in the alternative. When acknowledgement frames are used, DIFS may be used because there may be frames with different priorities.

A STA may include a processing device that may (i) receive, at the STA from an AP, a MU-RTS TXS trigger frame; (ii) send, from the STA to the AP, a CTS frame; (iii) send, from the STA to an additional STA, first data during a TXOP of the MU-RTS TXS trigger frame; and (iv) receive, at the STA from the additional STA, second data during the TXOP of the MU-RTS-TXS trigger frame.

The STA may receive, at the STA from the additional STA, an ACK message in response to sending the first data to the additional STA. The STA may receive the ACK message after an SIFS time. The STA may receive, at the STA from the additional STA, the second data after a CW back off. The STA may receive, at the STA from the additional STA, the second data after a DIFS time.

FIGS. 5A and 5B show reduced complexity contention mechanisms for a three-device P2P group, without acknowledgment and with acknowledgment mechanisms, respectively. In the first case, the STA devices skip DIFS and back-off a small contention window, expecting a very low rate of collisions, because the data traffic is driven by a common application service. In the case of using acknowledgment frames, the contention may allow these higher-priority frames. Therefore, the STA devices wait for DIFS time before starting with the back off time.

As illustrated in FIG. 5A, a timing diagram 500a is provided. A gained TXOP 505 may include a selected time duration. A time allocated to the P2P group may include a selected time duration (e.g., from the start of a CTS until the end of data transfer as shown by operation 544). An AP 510 may send a CTS-to-self signal, as shown in operation 511. The AP 510 may send an MU-RTS TXS trigger frame to STA1 520, STA2 530, STA3 540 as shown in operation 512. STA1 520 may send a CTS to the AP, as shown in operation 522. STA2 530 may send a CTS to the AP 510, as shown in operation 532. STA3 540 may send a CTS to the AP 510, as shown in operation 542. STA1 520 may send data to STA2 530, as shown in operation 524. After the data is sent from STA1 520 to STA2 530, a CW back-off may occur. The CW backoff may occur without waiting for a DIFS time. STA2 530 may send data to STA1 520, as shown in operation 534. STA1 520 may send additional data to STA2 530, as shown in operation 526. STA3 540 may send data to STA1 520, as shown in operation 544.

As illustrated in FIG. 5B, a timing diagram 500b is provided. Like numbers in FIG. 5B may have the same functionality as described with respect to like numbers in FIG. 5B. The data sent from STA1 510 to STA2 520, as shown in operation 524, may be acknowledged by STA2 520, as shown in operation 533. The data sent from STA2 530 to STA1 520, as shown in operation 534, may be acknowledged by STA1 520, as shown in operation 525. The data sent from STA3 540 to STA1 520, as shown in operation 544, may be acknowledged by STA1 520, as shown by operation 527.

The AP 510 may update the network allocation vector (NAV) counter of the network by sending a CTS-to-self frame, as shown in operation 511, and reserving the TXOP for itself. When the AP sends the Multi User (MU) Trigger frame to establish the P2P link, the AP resets the NAV counter of the P2P group, so the P2P group can start the contention for the channel. This is a light-weight DCF mechanism embedded within the shared TXOP, which may increase the airtime efficiency for a small number of P2P devices.

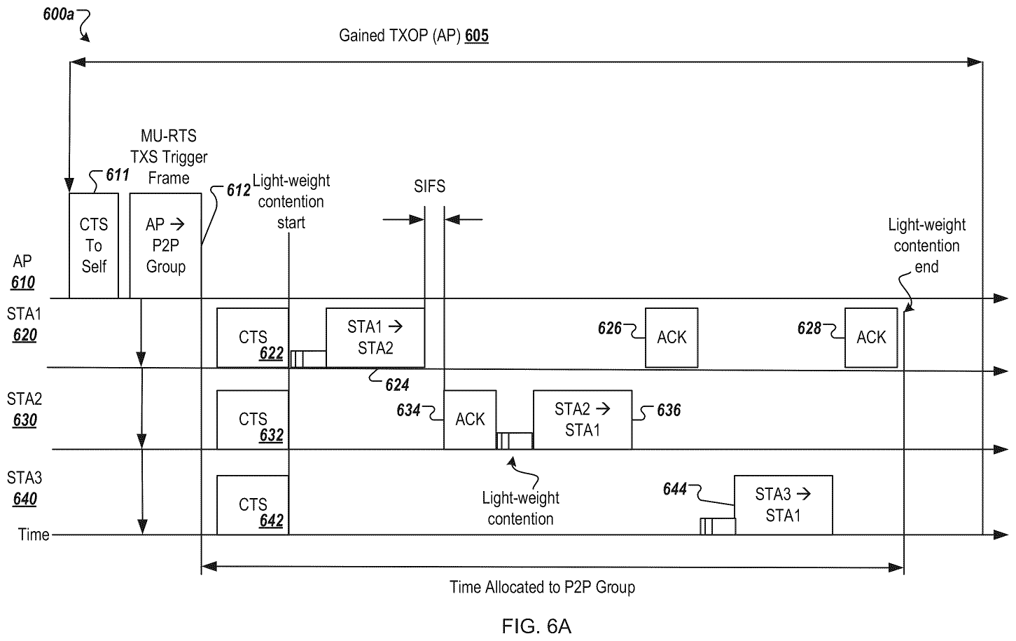

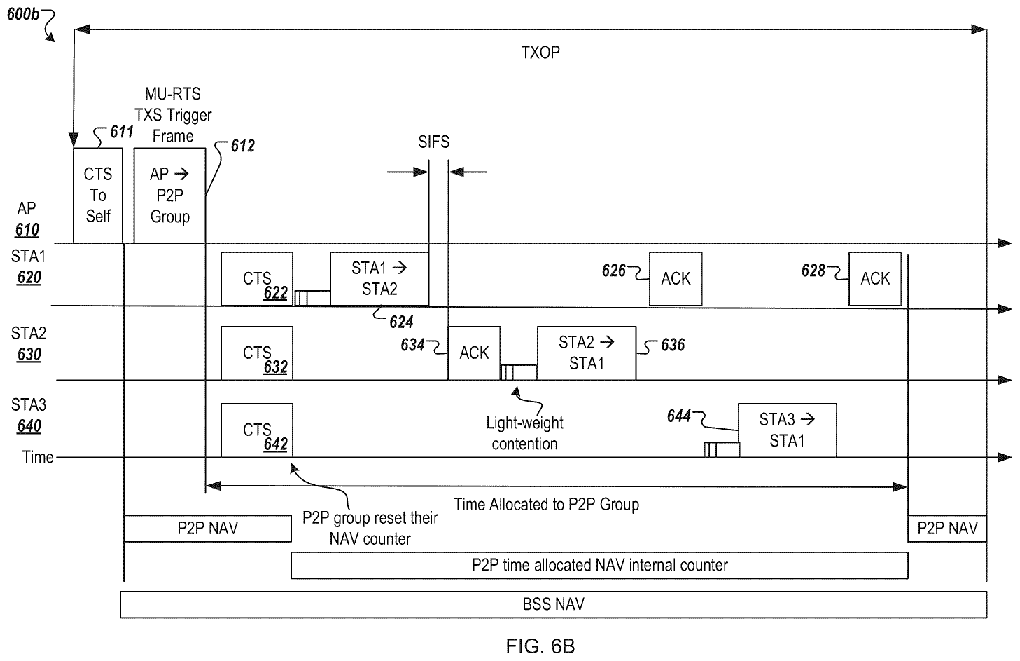

As illustrated in the timing diagram 600a in FIG. 6A, the AP's 610 granted TXOP (e.g., gained TXOP 605) time window may be seen as a local contention period for the P2P group (e.g., STA1 620, STA2 630, STA3 640) considered as a low congested scenario. The AP 610 may grant the time to allow data exchange in multiple directions within the group. To enhance the latency, the MU-RTS TXS trigger frame, sent by the AP 610, may include user information fields, to set the enhanced distributed channel access (EDCA) parameters of the P2P group (e.g., lowering arbitration inter-frame spacing (AISFN) and CW). Sending more than one user information field, covering the P2P group, may be used. The AP 610 may send a CTS to self, as shown in operation 611, and send an MU-RTS trigger frame from the AP to the P2P group, as shown in operation 612.

The triggered TXOP sharing mode may send the MU-RTS TXS trigger frame to the STA members in the P2P group (e.g., STA1 620, STA2 630, STA3 640). After the MU-RTS TXS trigger frame is received by the STA members in the P2P group, the STA members in the P2P group may send CTS frames to the AP, as shown in operations 622, 632, 642. After the CTS frames are sent, light-weight contention may start between the P2P group members (e.g., STA1 620, STA2 630, STA3 640) until the time allocated to the P2P group ends.

During a period of lightweight contention, STA1 620 may send data to STA2 630, as shown in operation 624. STA2 630 may send an ACK to STA1 620, as shown in operation 634. Before STA2 630 sends the ACK to STA1 620, there may be an SIFS. After STA2 630 sends the ACK to STA1 620, there may be lightweight contention. After the lightweight contention, STA2 630 may send data to STA1 620, as shown in operation 636. STA1 620 may send an ACK to STA2 630, as shown by operation 626. Another lightweight contention may occur before STA3 640 sends data to STA1 620, as shown by operation 644. STA 1 620 may send an ACK to STA3 640, as shown by operation 628. After operation 628, the period of light-weight contention may end. Thus, the period of lightweight contention starts after the CTS frames are sent and ends after the ACK from STA1 620 is sent to STA3. The period of lightweight contention is a subset of the time allocated to the P2P group.

A timing diagram is illustrated in FIG. 6B. Like numbers in FIG. 6B and FIG. 6A may have similar functionality. The NAV counter of the P2P group may be reset after sending the CTS frame, allowing the P2P group to start contending for the channel using the lightweight contention mode. Other STA devices, including overlapping basic service set (OBSS) devices, may not change the NAV, and may consider the channel as busy. Another internal time may count the remaining time for the allocated time. Once the allocated time finishes, the P2P group may restore the basic service set (BSS) NAV.

There may be several options for implementing the lightweight contention within the P2P group contention period. For example, high-performance EDCA parameters (AISFN and CW) may be used. The voice access category may be used to define these values. During the contention period there may be a small number of devices that are used. The devices may have quality of service (QoS) data traffic driven by the application, and there may be an order of transmission.

To summarize, a triggered TXOP sharing mode may be used which enables a light-weight contention period for QoS P2P group members. The MU-RTS TXS trigger frame may support more than one user information fields. The P2P group STAs may reset their NAV counter after sending the CTS frame, and start the light contention. The P2P group STAs may maintain an internal counter of the allocated time by the AP. After the allocated time expires, the P2P group STAs may recover the BSS TXOP NAV counter. There may be different light-weight contention options, according to application nature.

P2P communication links for some QoS time-sensitive applications, and current on-channel P2P mechanism limitations attending to bidirectional communication (closed loop) have been provided. Based on the P2P group concept, a triggered TXOP sharing mode may be used to allow direct communication with the P2P group. A light-weight contention mechanism may enhance the transmission efficiency and enhance the end-to-end communication latency.

There are various other ways of implementing P2P access mechanisms. In one example, no contention with fixed IFS may be provided. Assuming the application has a fixed order of data transmission, the contention may be removed, and set a fixed xIFS separation between the frames when there are no collisions.

In another example, token-based arbitration may be used. As an additional mechanism for avoiding collisions, there may be a token-based arbitration mechanism for allowing a P2P group member to transmit. The token may be passed through the members (different strategies may be used).

### Token-based Channel Access

Instead of using a contention-based mechanism within the shared TXOP window, the P2P group may use a token-based mechanism to allow access to the channel to the P2P devices. The token may be signaled in the 802.11 MAC header or 802.11 PHY header (e.g., universal signal field (U-SIG) reserved bits), which may follow a round-robin algorithm. The token may use the STA ID, assuming that the P2P group devices know each other, to grant access to the next device. The token may be passed on the data frame, or until the STA transmission buffer is empty.

A station (STA) may include a processing device operable to: receive, at the STA from an access point (AP), a multi-user request-to-send (MU-RTS) TXOP sharing (TXS) trigger frame; send, from the STA to the AP, a clear-to-send (CTS) frame; receive, at the STA from the AP, a channel access token; send, at the STA to a different STA, first data; send, at the STA to the different STA, the channel access token. The channel access token may include a station identifier. The channel access token may be signaled using one or more of an 802.11 medium access control (MAC) header or an 802.11 physical layer (PHY) header. The STA may receive, at the STA from the additional STA, an acknowledgment (ACK) message in response to sending the first data to the additional STA. The ACK message may be received after a short inter-frame space (SIFS) time.

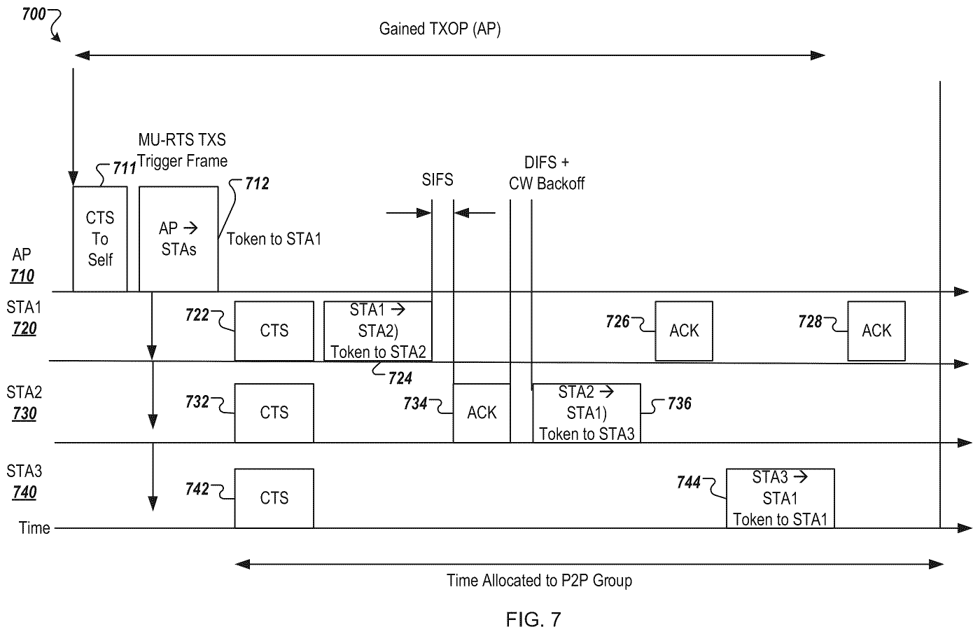

FIG. 7 shows an example timing diagram 700 of using a token-based mechanism for P2P frame exchange. The token may sent on the data frame, where the next STA may use a SIFS time after the acknowledgment frame of the previous transmission. When the channel access is arbitrated by the token, no collision may result along the shared TXOP time. At the beginning, the AP may update the NAV counter of the network devices. Each STA that receives the token may transmit frames.

As illustrated in FIG. 7, an AP 710 may send a CTS-to-Self to itself, as shown in operation 711. The AP 710 may send an MU-RTS TXS trigger frame to STA1 720, STA2 730, and STA3 740, as shown in operation 712. The AP 710 may send a token to STA1 720. STA1 720 may send a CTS to AP 710, as shown in operation 722. STA2 730 may send a CTS to AP 710, as shown in operation 732. STA3 740 may send a CTS to AP 710, as shown in operation 742. STA1 720 may send data to STA2 730 and may send a token to STA2730, as shown in operation 724. After operation 724, an SIFS time may occur. After the SIFS time, STA2 730 may send an ACK to STA1 720, as shown in operation 734. After the ACK in operation 734, a DIFS and CW back-off may occur. STA2 730 may send data to STA1 720 and send a token to STA3 740, as shown in operation 736. STA1 720 may send an ACK, as shown in operation 726. STA3 740 may send data to STA1 720 and may send a token to STA1 720, as shown in operation 744. STA1 720 may send an ACK to STA3 740, as shown in operation 728. The time allocated to the P2P group may begin after operation 712 and may end after operation 728.

### Dynamic Sub-band Operation for P2P Communication

Simultaneous P2P communication may be allowed in conjunction with AP transactions with other STAs from the same BSS, using dynamic sub-band operation by allocating the gained bandwidth during the contention process. In some examples, when the AP shares its TXOP and facilitates P2P access, the AP may not serve other associated STAs until the P2P access ends. This may result in an increase in network latency. To reduce the network latency, spectral resources may be shared in addition to time resources. Assuming the AP gets enough bandwidth during the initial contention process, the allocated bandwidth may be divided into a primary and secondary channel. While the AP and its associated STAs may continue transferring data on the primary channel, the P2P devices may jump to the secondary channel once the TXOP is shared. In this way, DL/UL and P2P transactions may continue simultaneously, reducing the increase of the latency. The time and spectrum resources may be shared from the acquired TXOP.

The AP may send an initial control frame (ICF) to announce the start of a new P2P group frame exchange, assigning the spectral resources to the P2P group, and indicating to the remaining associated STAs to stay at the primary channel. The involved STAs may answer with an initial control response (ICR) frame on their corresponding channel. The ICF may add some padding to create a delay and let the P2P group to tune to the new channel. Once the P2P group STAs switch to the secondary channel, they may start transferring data frames, using the allocated time. Simultaneously, the AP may initiate DL and UL trigger-based transactions during the same allocated time, parallelizing both processes.

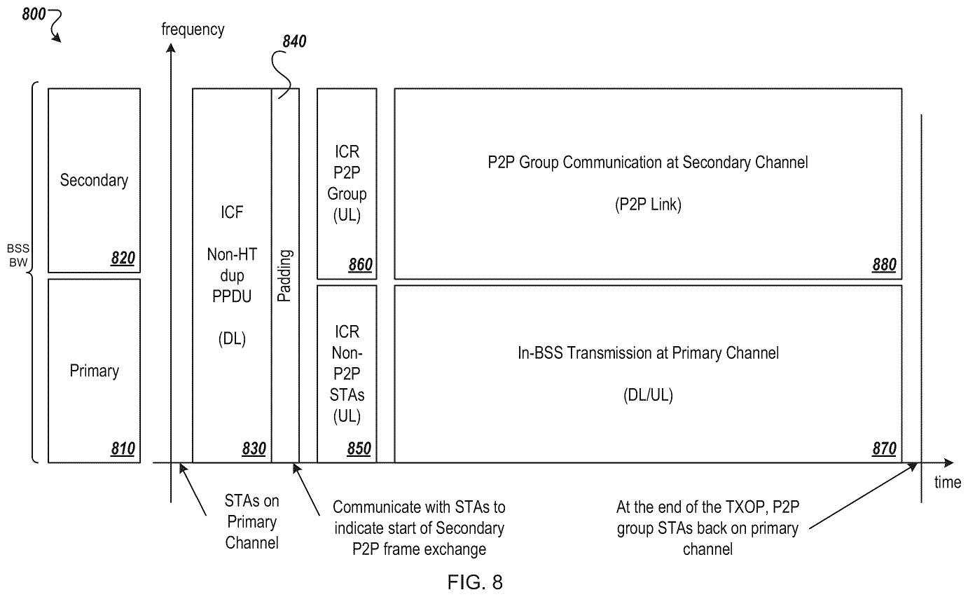

As illustrated in FIG. 8, an access point may facilitate dynamic sub-band operation for P2P communication as shown by the time/frequency diagram 800. An access point (AP) may include a processing device. The processing device may gain, at the AP, a specific bandwidth for a secondary channel 820 in a transmission opportunity (TXOP). The processing device may send, from the AP to a plurality of stations (STAs), an initial control frame (ICF) 830. The ICF 830 may signal a frame exchange start for a peer-to-peer (P2P) group of the plurality of STAs and assign the secondary channel 820 to the P2P group of the plurality of STAs. The processing device may receive, from the P2P group of the plurality of STAs on the secondary channel 820, a first set of initial control responses (ICRs) 860.

The ICF 830, which may be a non-high throughput (non-HT) duplicate physical layer protocol data unit (PPDU), may indicate to a non-P2P group of the plurality of STAs to continue communication on a primary channel 810. The processing device may receive, at the AP from the non-P2P group of the plurality of STAs on the primary channel, a second set of ICRs 850. The processing device may send, from the AP to the plurality of STAs, padding 840 after the ICF 830 to facilitate tuning by the P2P group to the secondary channel 820 by providing a delay. The P2P group may communicate in the secondary channel 820 using a P2P link, as shown by block 880. During this communication using the P2P link, in-BSS transmission may occur at the primary channel using DL/UL transactions, as shown by block 870.

The P2P group STAs of the plurality of STAs may switch between a primary channel and a secondary channel. The plurality of STAs may be on a primary channel before the ICF 830. During the padding 840, the start of secondary P2P frame exchange may commence. At the end of the TXOP, P2P group STAs may be back on the primary channel.

The processing device may initiate, at the AP, downlink (DL) and uplink (UL) trigger-based transactions when the P2P group transfers data frames. The processing device may terminate, at the AP, communication using the secondary channel 820 when the TXOP has expired. The plurality of STAs may be in a same basic service set (BSS).

A station may include a processing device. The processing device may receive, at the STA from an access point (AP), an initial control frame (ICF) 830. The processing device may determine, at the STA, a transmission opportunity (TXOP) based on the ICF 830. The processing device may determine, at the STA, an operating channel based on the ICF 830, wherein the operating channel is a primary channel 810 or a secondary channel 820. The processing device may send, from the STA to the AP, an initial control response (ICR) (e.g., first set of ICRs 860, or second set of ICRs 850) frame on the operating channel.

The processing device may switch, at the STA, from the primary channel 810 to the secondary channel 820 when the ICF 830 indicates the operating channel is a secondary channel 820. The processing device may send, from the STA to a different STA, data using the secondary channel 820. The processing device may receive, at the STA from a different STA, data using the secondary channel 820. The processing device may terminate, at the STA, communication using the secondary channel 820 when a transmission opportunity (TXOP) has expired. The processing device may continue, at the STA, on the primary channel 810 when the ICF 830 indicates the operating channel is the primary channel 810. The processing device may receive, at the STA from the AP, DL trigger-based transactions during the TXOP; and send, from the STA to the AP, UL trigger-based transactions during the TXOP.

Frame exchange may be performed between the AP and the STAs. First, the AP may contend for the channel and may gain a specific bandwidth, which may aim to allocate time and frequency resources. On the one hand, the P2P group STAs may receive the ICF with the information of time allocated for the P2P link, and the indication for the secondary channel used for such communication. The remaining associated STAs may receive the ICF indicating that the remaining associated STAs may continue using the primary channel. During the allocated time, the AP may start transferring data and the P2P group devices may do the same, each group in their corresponding channel, with no overlap or collisions. Once the allocated time ends, the STAs, including the AP, may go back to their BSS primary channel.

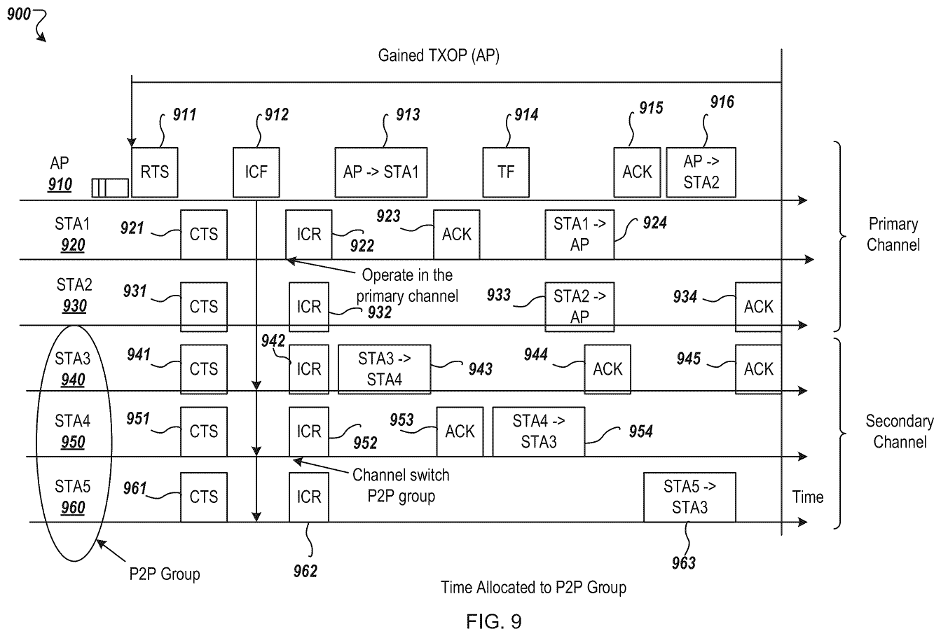

As illustrated in the timing diagram 900 in FIG. 9, a gained TXOP may be determined by the AP 910. The AP 910 may send a request to send (RTS) 911 to STAs 920, 930, 940, 950, 960. The STAs 920, 930, 940, 950, 960 may respond with clear to send (CTS) 921, 931, 941, 951, 961. The AP 910 may send an ICF 912 to the STAs 920, 930, 940, 950, 960. The STAs 920, 930, 940, 950, 960 may respond to the AP with ICR frames 922, 932, 942, 952, 962.

After the ICR frames 922, 932, 942, 952, 962 have been sent to the AP 910, the AP 910 may communicate with STA1 920 and STA2 930 in the primary channel while STA3 940, STA4 950, and STA5 960 may communicate with each other in the secondary channel as a P2P group. For example, the AP 910 may send data to STA1 920 as shown by block 913. This data may be acknowledged by STA1 920 as shown by block 923. The AP 910 may send a trigger frame, as shown by block 914, which may result in data being sent from STA 1 920 to the AP 910, as shown by block 924 and data being sent from STA2 930 to the AP 910, as shown by block 933. The AP 910 may acknowledge the data as shown by block 915. The AP 910 may further send data to STA2 930, as shown by block 916. This data may be acknowledged by STA2 930 as shown by block 934.

STA 3 940, STA4 950, and STA5 960 may communicate with each other while AP 910 is communicating with STA1 920 and STA2 930. For example, as shown by block 943, STA3 940 may send data to STA4 950, which data may be acknowledged by STA4 950 as shown by block 953. Block 943 may occur at the same time as block 913 and block 953 may occur at the same time as block 923. In addition, STA4 950 may send data to STA3 940 as shown by block 954, which data may acknowledged by STA3 940 as shown by block 944. Block 954 may partially occur during the same time as block 914 and block 944 may occur at the same time as blocks 924 and 933. In addition, STA5 960 may send data to STA3 940 as shown by block 963, which data may be acknowledged by STA3 940 as shown by block 945. Block 964 may occur during the same time as blocks 915 and 916 and block 945 may occur during the same time as block 934. Therefore, various blocks may overlap in time when different channels are used.

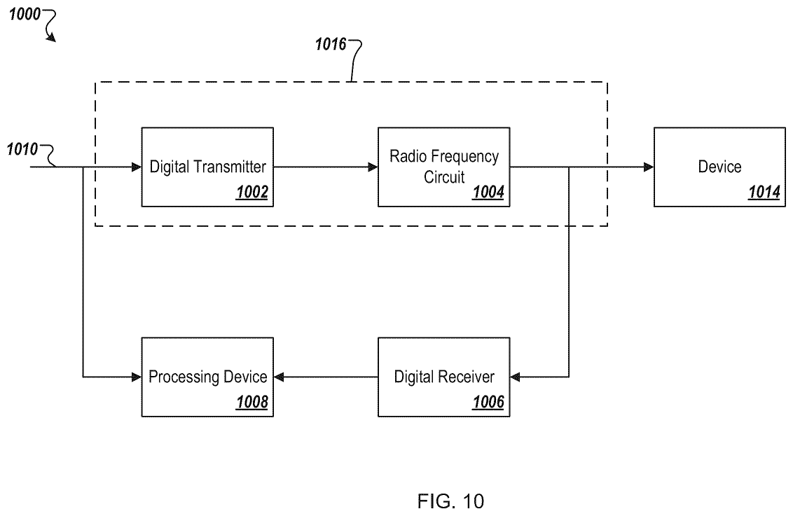

FIG. 10 illustrates a block diagram of an example communication system 1000 configured for P2P communication, in accordance with at least one example described in the present disclosure. The communication system 1000 may include a digital transmitter 1002, a radio frequency circuit 1004, a device 1014, a digital receiver 1006, and a processing device 1008. The digital transmitter 1002 and the processing device 1008 may be configured to receive a baseband signal via connection 1010. A transceiver 1016 may comprise the digital transmitter 1002 and the radio frequency circuit 1004.

In some examples, the communication system 1000 may include a system of devices that may be configured to communicate with one another via a wired or wireline connection. For example, a wired connection in the communication system 1000 may include one or more Ethernet cables, one or more fiber-optic cables, and/or other similar wired communication mediums. Alternatively, or additionally, the communication system 1000 may include a system of devices that may be configured to communicate via one or more wireless connections. For example, the communication system 1000 may include one or more devices configured to transmit and/or receive radio waves, microwaves, ultrasonic waves, optical waves, electromagnetic induction, and/or similar wireless communications. Alternatively, or additionally, the communication system 1000 may include combinations of wireless and/or wired connections. In these and other examples, the communication system 1000 may include one or more devices that may be configured to obtain a baseband signal, perform one or more operations to the baseband signal to generate a modified baseband signal, and transmit the modified baseband signal, such as to one or more loads.

In some examples, the communication system 1000 may include one or more communication channels that may communicatively couple systems and/or devices included in the communication system 1000. For example, the transceiver 1016 may be communicatively coupled to the device 1014.

In some examples, the transceiver 1016 may be configured to obtain a baseband signal. For example, as described herein, the transceiver 1016 may be configured to generate a baseband signal and/or receive a baseband signal from another device. In some examples, the transceiver 1016 may be configured to transmit the baseband signal. For example, upon obtaining the baseband signal, the transceiver 1016 may be configured to transmit the baseband signal to a separate device, such as the device 1014. Alternatively, or additionally, the transceiver 1016 may be configured to modify, condition, and/or transform the baseband signal in advance of transmitting the baseband signal. For example, the transceiver 1016 may include a quadrature up-converter and/or a digital to analog converter (DAC) that may be configured to modify the baseband signal. Alternatively, or additionally, the transceiver 1016 may include a direct radio frequency (RF) sampling converter that may be configured to modify the baseband signal.

In some examples, the digital transmitter 1002 may be configured to obtain a baseband signal via connection 1010. In some examples, the digital transmitter 1002 may be configured to up-convert the baseband signal. For example, the digital transmitter 1002 may include a quadrature up-converter to apply to the baseband signal. In some examples, the digital transmitter 1002 may include an integrated digital to analog converter (DAC). The DAC may convert the baseband signal to an analog signal, or a continuous time signal. In some examples, the DAC architecture may include a direct RF sampling DAC. In some examples, the DAC may be a separate element from the digital transmitter 1002.

In some examples, the transceiver 1016 may include one or more subcomponents that may be used in preparing the baseband signal and/or transmitting the baseband signal. For example, the transceiver 1016 may include an RF front end (e.g., in a wireless environment) which may include a power amplifier (PA), a digital transmitter (e.g., 1002), a digital front end, an Institute of Electrical and Electronics Engineers (IEEE) 1588v2 device, a Long-Term Evolution (LTE) physical layer (L-PHY), an (S-plane) device, a management plane (M-plane) device, an Ethernet media access control (MAC)/personal communications service (PCS), a resource controller/scheduler, and the like. In some examples, a radio (e.g., a radio frequency circuit 1004) of the transceiver 1016 may be synchronized with the resource controller via the S-plane device, which may contribute to high-accuracy timing with respect to a reference clock.

In some examples, the transceiver 1016 may be configured to obtain the baseband signal for transmission. For example, the transceiver 1016 may receive the baseband signal from a separate device, such as a signal generator. For example, the baseband signal may come from a transducer configured to convert a variable into an electrical signal, such as an audio signal output of a microphone picking up a speaker's voice. Alternatively, or additionally, the transceiver 1016 may be configured to generate a baseband signal for transmission. In these and other examples, the transceiver 1016 may be configured to transmit the baseband signal to another device, such as the device 1014.

In some examples, the transceiver 1016 may be configured to receive a transmission from the transceiver 1016. For example, the transceiver 1016 may be configured to transmit a baseband signal to the device 1014.

In some examples, the radio frequency circuit 1004 may be configured to transmit the digital signal received from the digital transmitter 1002. In some examples, the radio frequency circuit 1004 may be configured to transmit the digital signal to the device 1014 and/or the digital receiver 1006. In some examples, the digital receiver 1006 may be configured to receive a digital signal from the RF circuit and/or send a digital signal to the processing device 1008.

In some examples, the processing device 1008 may be a standalone device or system, as illustrated. Alternatively, or additionally, the processing device 1008 may be a component of another device and/or system. For example, in some examples, the processing device 1008 may be included in the transceiver 1016. In instances in which the processing device 1008 is a standalone device or system, the processing device 1008 may be configured to communicate with additional devices and/or systems remote from the processing device 1008, such as the transceiver 1016 and/or the device 1014. For example, the processing device 1008 may be configured to send and/or receive transmissions from the transceiver 1016 and/or the device 1014. In some examples, the processing device 1008 may be combined with other elements of the communication system 1000.

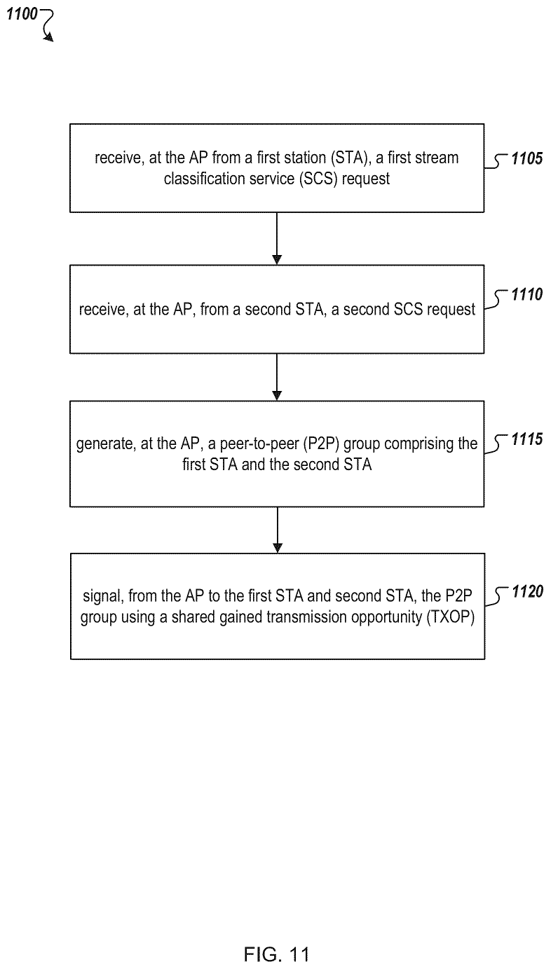

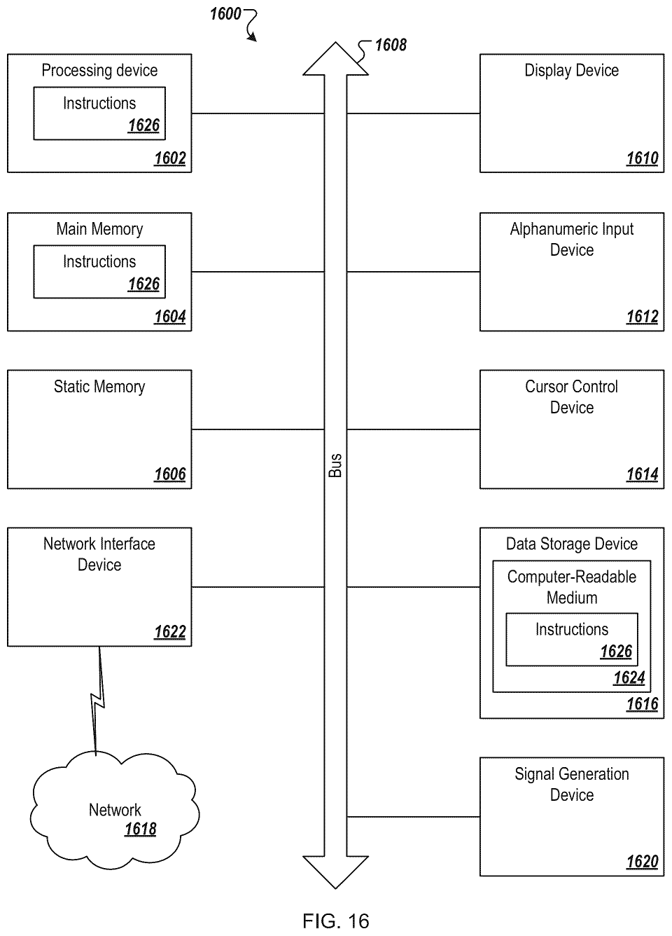

FIG. 11 illustrates a process flow of an example method 1100 of P2P communication, in accordance with at least one example described in the present disclosure. The method 1100 may be arranged in accordance with at least one example described in the present disclosure. The method 1100 may be performed by processing logic that may include hardware (circuitry, dedicated logic, etc.), software (such as is run on a computer system or a dedicated machine), or a combination of both, which processing logic may be included in the processor (e.g., the processing device 1602 of FIG. 16), the communication system 1000 of FIG. 10, or another device, combination of devices, or systems.

The method 1100 may begin at block 1105 where the processing logic may receive, at the AP from a first station (STA), a first stream classification service (SCS) request.

At block 1110, the processing logic may receive, at the AP, from a second STA, a second SCS request.

At block 1115, the processing logic may generate, at the AP, a peer-to-peer (P2P) group comprising the first STA and the second STA.

At block 1120, the processing logic may signal, from the AP to the first STA and second STA, the P2P group using a shared gained transmission opportunity (TXOP).

Modifications, additions, or omissions may be made to the method 1100 without departing from the scope of the present disclosure. For example, in some examples, the method 1100 may include any number of other components that may not be explicitly illustrated or described.

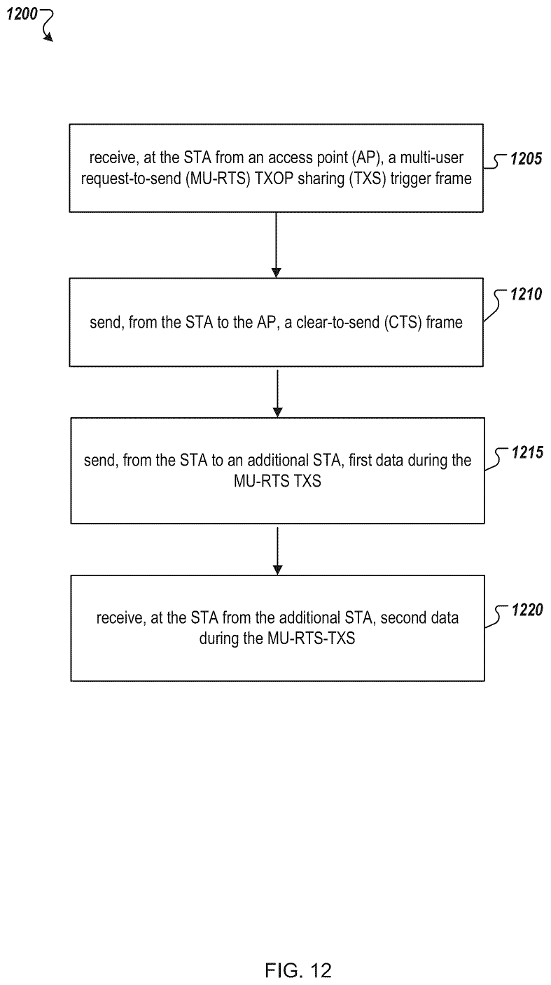

FIG. 12 illustrates a process flow of an example method 1200 of P2P communication, in accordance with at least one example described in the present disclosure. The method 1200 may be arranged in accordance with at least one example described in the present disclosure.

The method 1200 may be performed by processing logic that may include hardware (circuitry, dedicated logic, etc.), software (such as is run on a computer system or a dedicated machine), or a combination of both, which processing logic may be included in the processor (e.g., the processing device 1602 of FIG. 16), the communication system 1000 of FIG. 10, or another device, combination of devices, or systems.

The method 1200 may begin at block 1205 where the processing logic may receive, at the STA from an access point (AP), a multi-user request-to-send (MU-RTS) TXOP sharing (TXS) trigger frame.

At block 1210, the processing logic may send, from the STA to the AP, a clear-to-send (CTS) frame.

At block 1215, the processing logic may send, from the STA to an additional STA, first data during the MU-RTS TXS.

At block 1220, the processing logic may receive, at the STA from the additional STA, second data during the MU-RTS-TXS.

Modifications, additions, or omissions may be made to the method 1200 without departing from the scope of the present disclosure. For example, in some examples, the method 1200 may include any number of other components that may not be explicitly illustrated or described.

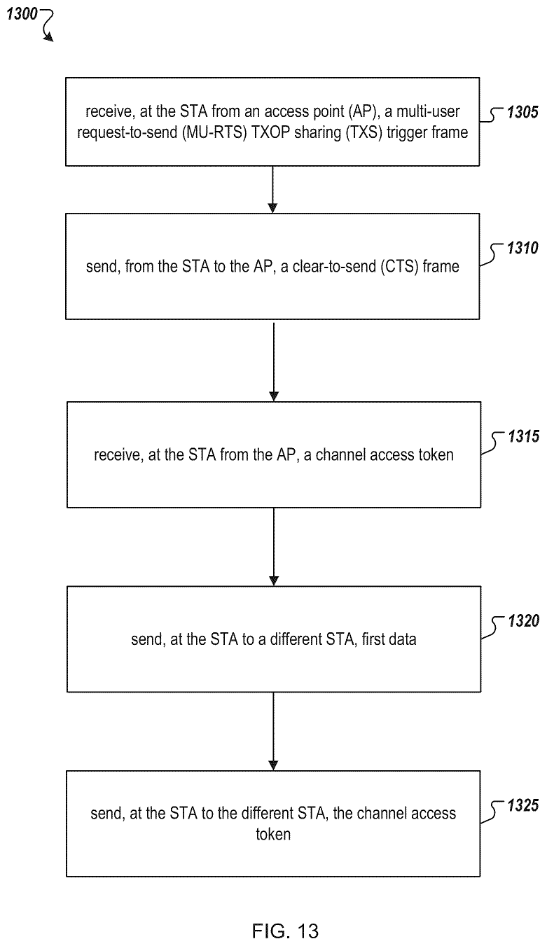

FIG. 13 illustrates a process flow of an example method 1300 of P2P communication, in accordance with at least one example described in the present disclosure. The method 1300 may be arranged in accordance with at least one example described in the present disclosure.

The method 1300 may be performed by processing logic that may include hardware (circuitry, dedicated logic, etc.), software (such as is run on a computer system or a dedicated machine), or a combination of both, which processing logic may be included in the processor (e.g., the processing device 1602 of FIG. 16), the communication system 1000 of FIG. 10, or another device, combination of devices, or systems.

The method 1300 may begin at block 1305 where the processing logic may receive, at the STA from an access point (AP), a multi-user request-to-send (MU-RTS) TXOP sharing (TXS) trigger frame.

At block 1310, the processing logic may send, from the STA to the AP, a clear-to-send (CTS) frame.

At block 1315, the processing logic may receive, at the STA from the AP, a channel access token.

At block 1320, the processing logic may send, at the STA to a different STA, first data.

At block 1325, the processing logic may send, at the STA to the different STA, the channel access token.

Modifications, additions, or omissions may be made to the method 1300 without departing from the scope of the present disclosure. For example, in some examples, the method 1300 may include any number of other components that may not be explicitly illustrated or described.

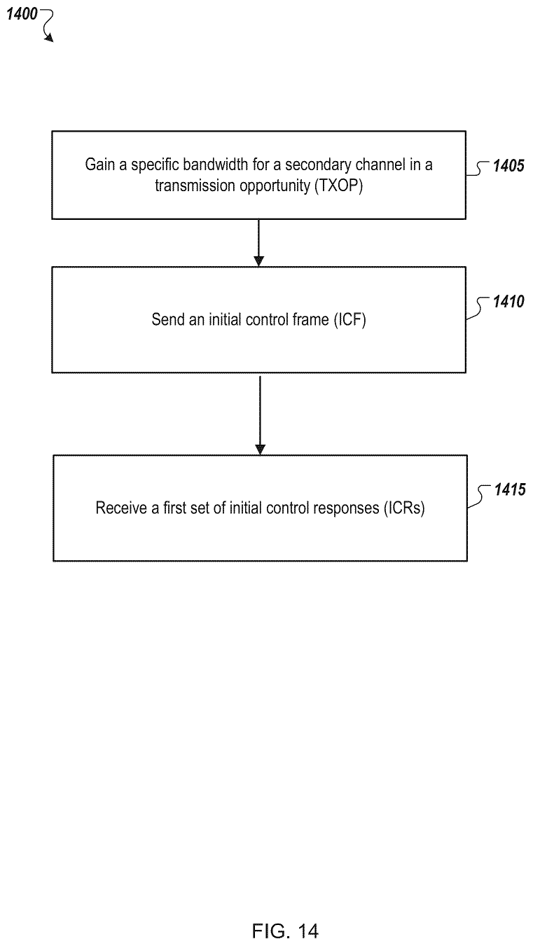

FIG. 14 illustrates a process flow of an example method 1400 of dynamic sub-band operation, in accordance with at least one example described in the present disclosure. The method 1400 may be arranged in accordance with at least one example described in the present disclosure.

The method 1400 may be performed by processing logic that may include hardware (circuitry, dedicated logic, etc.), software (such as is run on a computer system or a dedicated machine), or a combination of both, which processing logic may be included in the processor (e.g., the processing device 1602 of FIG. 16), the communication system 1000 of FIG. 10, or another device, combination of devices, or systems.

The method 1400 may begin at block 1405 where the processing logic may gain, at the AP, a specific bandwidth for a secondary channel in a transmission opportunity (TXOP).

At block 1410, the processing logic may send, from the AP to a plurality of stations (STAs), an initial control frame (ICF). The ICF may signal a frame exchange start for a peer-to-peer (P2P) group of the plurality of STAs and may assign the secondary channel to the P2P group of the plurality of STAs.

At block 1415, the processing logic may receive, from the P2P group of the plurality of STAs on the secondary channel, a first set of initial control responses (ICRs).

Modifications, additions, or omissions may be made to the method 1400 without departing from the scope of the present disclosure. For example, in some examples, the method 1400 may include any number of other components that may not be explicitly illustrated or described.

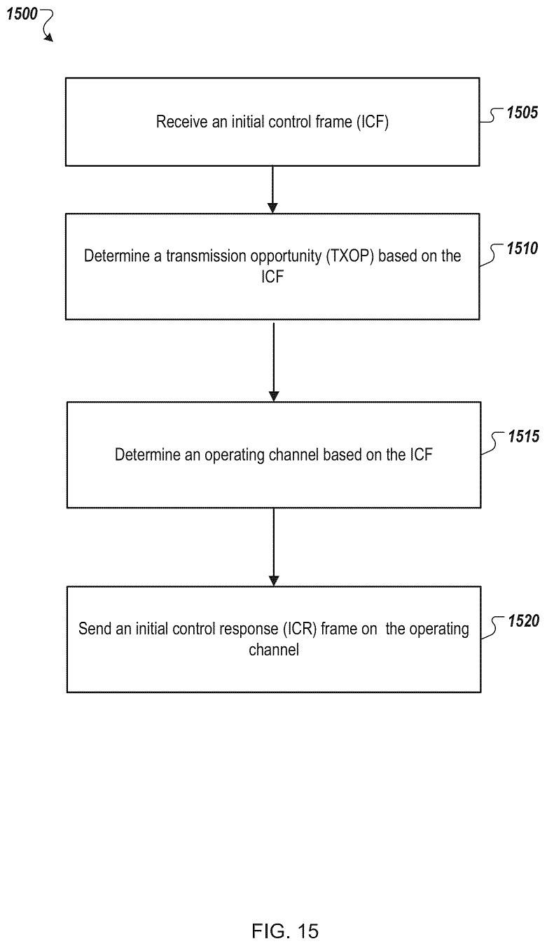

FIG. 15 illustrates a process flow of an example method 1500 of dynamic sub-band operation, in accordance with at least one example described in the present disclosure. The method 1500 may be arranged in accordance with at least one example described in the present disclosure.

The method 1500 may be performed by processing logic that may include hardware (circuitry, dedicated logic, etc.), software (such as is run on a computer system or a dedicated machine), or a combination of both, which processing logic may be included in the processor (e.g., the processing device 1602 of FIG. 16), the communication system 1000 of FIG. 10, or another device, combination of devices, or systems.

The method 1500 may begin at block 1505 where the processing logic may receive, at the STA from an access point (AP), an initial control frame (ICF).

At block 1510, the processing logic may determine, at the STA, a transmission opportunity (TXOP) based on the ICF.

At block 1515, the processing logic may determine, at the STA, an operating channel based on the ICF, wherein the operating channel is a primary channel or a secondary channel.

At block 1520, the processing logic may send, from the STA to the AP, an initial control response (ICR) frame on the operating channel.

Modifications, additions, or omissions may be made to the method 1500 without departing from the scope of the present disclosure. For example, in some examples, the method 1500 may include any number of other components that may not be explicitly illustrated or described.

For simplicity of explanation, methods and/or process flows described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

FIG. 16 illustrates a diagrammatic representation of a machine in the example form of a computing device 1600 within which a set of instructions, for causing the machine to perform any one or more of the methods discussed herein, may be executed. The computing device 1600 may include a rackmount server, a router computer, a server computer, a mainframe computer, a laptop computer, a tablet computer, a desktop computer, or any computing device with at least one processor, etc., within which a set of instructions, for causing the machine to perform any one or more of the methods discussed herein, may be executed. In alternative examples, the machine may be connected (e.g., networked) to other machines in a local area network (LAN), an intranet, an extranet, or the Internet. The machine may operate in the capacity of a server machine in client-server network environment. Further, while only a single machine is illustrated, the term “machine” may also include any collection of machines that individually or jointly execute a set (or multiple sets) of instructions to perform any one or more of the methods discussed herein.

The example computing device 1600 includes a processing device 1602, a main memory 1604 (e.g., read-only memory (ROM), flash memory, dynamic random access memory (DRAM) such as synchronous DRAM (SDRAM)), a static memory 1606 (e.g., flash memory, static random access memory (SRAM)) and a data storage device 1616, which communicate with each other via a bus 1608.

Processing device 1602 represents one or more general-purpose processing devices such as a microprocessor, central processing unit, or the like. More particularly, the processing device 1602 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 1602 may also include one or more special-purpose processing devices such as an application specific integrated circuit (ASIC), a field programmable gate array (FPGA), a digital signal processor (DSP), network processor, or the like. The processing device 1602 is configured to execute instructions 1626 for performing the operations and steps discussed herein.

The computing device 1600 may further include a network interface device 1622 which may communicate with a network 1618. The computing device 1600 also may include a display device 1610 (e.g., a liquid crystal display (LCD) or a cathode ray tube (CRT)), an alphanumeric input device 1612 (e.g., a keyboard), a cursor control device 1614 (e.g., a mouse) and a signal generation device 1620 (e.g., a speaker). In at least one example, the display device 1610, the alphanumeric input device 1612, and the cursor control device 1614 may be combined into a single component or device (e.g., an LCD touch screen).

The data storage device 1616 may include a computer-readable storage medium 1624 on which is stored one or more sets of instructions 1626 embodying any one or more of the methods or functions described herein. The instructions 1626 may also reside, completely or at least partially, within the main memory 1604 and/or within the processing device 1602 during execution thereof by the computing device 1600, the main memory 1604 and the processing device 1602 also constituting computer-readable media. The instructions may further be transmitted or received over a network 1618 via the network interface device 1622.

While the computer-readable storage medium 1624 is shown in an example to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

In some examples, the different components, modules, engines, and services described herein may be implemented as objects or processes that execute on a computing system (e.g., as separate threads). While some of the systems and methods described herein are generally described as being implemented in software (stored on and/or executed by hardware), specific hardware implementations or a combination of software and specific hardware implementations are also possible and contemplated.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although examples of the present disclosure have been described in detail, it should be understood that the various changes, substitutions, and alterations could be made hereto without departing from the spirit and scope of the present disclosure.

What is claimed is:

1. An access point (AP), comprising:
a processing device operable to:
gain, at the AP, a specific bandwidth for a secondary channel in a transmission opportunity (TXOP);
send, from the AP to a plurality of stations (STAs), an initial control frame (ICF), wherein the ICF signals a frame exchange start for a peer-to-peer (P2P) group of the plurality of STAs and assigns the secondary channel to the P2P group of the plurality of STAs; and
receive, from the P2P group of the plurality of STAs on the secondary channel, a first set of initial control responses (ICRs).

2. The AP of claim 1, wherein the ICF indicates to a non-P2P group of the plurality of STAs to continue communication on a primary channel.

3. The AP of claim 2, wherein the processing device is further operable to:
receive, at the AP from the non-P2P group of the plurality of STAs on the primary channel, a second set of ICRs.

4. The AP of claim 1, wherein the processing device is further operable to:
send, from the AP to the plurality of STAs, padding after the ICF to facilitate tuning by the P2P group to the secondary channel.

5. The AP of claim 1, wherein the processing device is further operable to:
initiate, at the AP, downlink (DL) and uplink (UL) trigger-based transactions when the P2P group transfers data frames.

6. The AP of claim 1, wherein the processing device is further operable to:
terminate, at the AP, communication using the secondary channel when the TXOP has expired.

7. The AP of claim 1, wherein the plurality of STAs are in a same basic service set (BSS).

8. A station (STA), comprising:
a processing device operable to:
receive, at the STA from an access point (AP), an initial control frame (ICF);
determine, at the STA, a transmission opportunity (TXOP) based on the ICF;
determine, at the STA, an operating channel based on the ICF, wherein the operating channel is a primary channel or a secondary channel; and
send, from the STA to the AP, an initial control response (ICR) frame on the operating channel.

9. The station of claim 8, wherein the processing device is further operable to:
switch, at the STA, from the primary channel to the secondary channel when the ICF indicates the operating channel is a secondary channel.

10. The station of claim 9, wherein the processing device is further operable to:
send, from the STA to a different STA, data using the secondary channel.

11. The station of claim 9, wherein the processing device is further operable to:
receive, at the STA from a different STA, data using the secondary channel.

12. The station of claim 9, wherein the processing device is further operable to:
terminate, at the STA, communication using the secondary channel when a transmission opportunity (TXOP) has expired.

13. The station of claim 8, wherein the processing device is further operable to:
continue, at the STA, on the primary channel when the ICF indicates the operating channel is the primary channel.

14. The station of claim 8, wherein the processing device is further operable to:
receive, at the STA from the AP, DL trigger-based transactions during the TXOP; and
send, from the STA to the AP, UL trigger-based transactions during the TXOP.

15. A method, comprising:
gaining, at an access point (AP), a specific bandwidth for a secondary channel in a transmission opportunity (TXOP);
sending, from the AP to a plurality of stations (STAs), an initial control frame (ICF), wherein the ICF signals a frame exchange start for a peer-to-peer (P2P) group of the plurality of STAs and assigns the secondary channel to the P2P group of the plurality of STAs; and
receiving, from the P2P group of the plurality of STAs on the secondary channel, a first set of initial control responses (ICRs).

16. The method of claim 15, wherein the ICF indicates to a non-P2P group of the plurality of STAs to continue communication on a primary channel.

17. The method of claim 16, further comprising:
receiving, at the AP from the non-P2P group of the plurality of STAs on the primary channel, a second set of ICRs.

18. The method of claim 15, further comprising:
sending, from the AP to the plurality of STAs, padding after the ICF to facilitate tuning by the P2P group to the secondary channel.

19. The method of claim 15, further comprising:
initiating, at the AP, downlink (DL) and uplink (UL) trigger-based transactions when the P2P group transfers data frames.

20. The method of claim 15, further comprising:
terminating, at the AP, communication using the secondary channel when the TXOP has expired.
